(19) United States
(12) Patent Application Publication
(10) Pub. No.: US 2006/0205908 A1
(43) Pub. Date: Sep. 14, 2006

(54) Fast curing liquid silicone rubbers

(76) Inventors: Daniel T. Laur, Sanford, MI (US); Paul Kehl, Midland, MI (US)

Correspondence Address: MCKELLAR IP LAW, PLLC, 784 SOUTH POSEYVILLE ROAD, MIDLAND, MI, 48640, US

(21) Appl. No.: 11/430,102

(22) Filed: May 8, 2006

Related U.S. Application Data
(63) Continuation-in-part of application No. 10/683,686, filed on Oct. 10, 2003.

(51) Int. Cl. C08G 77/12; C08G 77/20

(52) U.S. Cl. 528/24; 528/31; 528/32

(57) ABSTRACT

Compositions of matter that are curable liquid silicone rubbers that when provided with the appropriate levels of both silicon hydride and organic peroxides provide fast curing one part silicone systems.

This application claims priority from US Utility application 10/683,686 filed Oct. 10, 2003.

The invention disclosed and claimed herein deals with new compositions of matter that are curable liquid silicone rubbers that when provided with the appropriate levels of both silicon hydrogen and organic peroxides, provide fast curing one part or two part silicone systems.

### BACKGROUND OF THE INVENTION

Curable silicone rubber systems are known. In the art, there is shown curable high consistency silicone rubbers and liquid silicone rubbers that are low consistency rubbers. These systems generally consist of organic peroxide cured systems and addition cure reactions consisting of the addition of silicone hydride to unsaturated groups.

What is meant by silicon hydride, or silicone hydrogen herein are materials that have hydrogen bonded directly to a silicon atom.

Peroxide cured systems conventionally consist of polysiloxanes having unsaturated groups using organic peroxides as curing agents, and the systems are heated to cure them.

Curable liquid silicone rubber systems consisting of the addition type curing are well known, and can be purchased commercially as two part systems. Part A generally consists of a catalyst, typically platinum, dispersed in a methylvinylpolysiloxane. Part B generally consists of a methylhydrogenpolysiloxane that is the crosslinking agent for the curable system, and it also contains methylvinylpolysiloxane, generally, the same type of methylvinylpolysiloxane that is part of Part A. The methylhydrogenpolysiloxane that is provided as Part B is one in which a low amount of hydrogen on silicon is used, on the order of 1.2 to 4 hydrogens for each vinyl present in the methylvinylpolysiloxane. On heating, this mixture will crosslink into a solid elastomer.

Attention is directed to U.S. Pat. No. 5,006,372 that issued on Apr. 9, 1991 to Wolfer in which there is shown a curable system consisting of an organopolysiloxane containing Si-bonded vinyl groups; an organopolysiloxane containing Si-bonded hydrogen groups; a platinum catalyst that promotes the addition of Si-bonded hydrogen to the vinyl groups; an inhibitor that delays the addition reaction of Si-bonded hydrogen with the vinyl groups at room temperature, and an organic peroxide. Thus, this system is an addition type curing system. This system differs from the invention taught herein in that at the very least, it contains platinum as a curing catalyst. It should be noted that this system is highly preferred to be a two part system in that the curing reaction begins immediately upon the combination of the two parts, while the systems disclosed and claimed herein can be one part systems and such inventive systems have long shelf lives.

U.S. Pat. No. 6,194,508, that issued on Feb. 27, 2001 to Achenbach, et al deals with peroxide cured cross linkable silicone rubber that is a high consistency rubber. The cross linkable silicone rubber composition comprises cross linkable polyorganosiloxanes, one or more peroxide crosslinking catalysts, and a filler that has been treated to provide a filler for the system that has covalently bound SiH containing groups.

This disclosure differs from that disclosed herein by virtue of the fact that it does not use polymethylhydrogensiloxanes as the source of the SiH and it deals with a high consistency rubber rather than a liquid silicone rubber system.

There is disclosed in German patent 3243194 that issued to Bode, et al, that was published May 24, 1984, a curable silicone rubber mixture containing silicon dioxide that is vulcanized by peroxide in the presence of polymethyl hydrogen siloxanes. This system is a high consistency system as can be observed from the samples wherein the compositions are prepared on a roll mill. A close reading of this patent shows that it does not deal with liquid silicone rubber systems.

Another patent dealing with cross linkable silicone rubbers is U.S. Pat. No. 5,652,290, that issued on Jul. 29, 1997 to Nakamura in which there is described high consistency silicone rubbers that are cured using silicon hydride cross linkers.

In addition, Reitmeier et al in U.S. Pat. No. 6,790,533 that issued Sep. 14, 2004 deals with self-adhesive thermally cross linkable 1-component silicone compositions.

Hatanaka et al in U.S. Pat. No. 4,329,275 discloses a heat-curable polysiloxane composition that is platinum catalyzed, the composition containing silicon hydride as the cross linker.

Finally, U.S. Pat. No. 6,734,250 that issued on May 11, 2004 to Azechi, et al, deals with electrically conductive silicone rubber compositions that are comprised of an organopolysiloxane having at least two aliphatic unsaturated groups, finely divided silica, a metal powder or an electrically conductive metal-plated powder, an adhesive aid and a curing agent, that cures into silicone rubber having a low volumetric resistivity and a stable high conductivity, exhibiting improved adhesion to resin and metal substrates, suitable as electrically conductive parts and electrical contacts in electrical equipment.

### THE INVENTION

What is disclosed and claimed herein is a curable liquid silicone rubber comprising a cross linkable vinyl containing organopolysiloxane wherein each vinyl is bonded to a silicon atom, specific silicon hydride materials, and organic peroxides.

The inventors herein have discovered that the addition of certain silicon hydride containing materials and peroxides to vinyl-containing cross linkable organopolysiloxanes directly affects the cure rate of the cross linkable organopolysiloxane, in that, the rate of cure is highly enhanced over that of peroxide cures and the rate of cure for this system mimics the addition type cures, yet the uncured mixture is stable, that is, the mixture does not appreciably cure while standing for periods of months.

For purposes of this invention, the cross linkable vinyl containing organo-polysiloxane of this invention is a vinyl-containing polydimethylsiloxane or a blend of vinyl-containing polydimethylsiloxanes of differing viscosities having a degree of polymerization of less than 1,000. These materials may contain other ingredients such as fillers, both reinforcing and non-reinforcing fillers, as well as those adjuvants that are common in the production of silicone rubber. Such vinyl-containing polydimethylsiloxanes can also contain other groups bonded to silicone in place of some of the methyl groups, such as, for example, fluoralkyl, phenyl, and the like.

With regard to the polymethylhydrogen siloxanes used in this invention, one such material that is useful is polymethylhydrogen organopolysiloxanes that are essentially linear polysiloxanes in which essentially all of the repeating units of the siloxane contain a methyl group and a hydrogen atom wherein none of the hydrogen atoms are on terminal ends of the polysiloxanes, but are all located along the polysiloxane chain. The polymethylhydrogen organopolysiloxanes can be end blocked with trimethylsiloxy groups, or they can have some of such methyl groups replaced by hydroxyl groups, or some of the methyl groups can be replaced with fluoroalkyl groups, or phenyl groups, or the like. Such replacement should not exceed more than about 1 weight percent of the total weight of the polysiloxane. Further, it is contemplated within the scope of this invention that the polymethylhydrogen organopolysiloxanes can have other di-substituted siloxane units in the chain, such as dimethyl siloxane units. For purposes of this invention, up to about ten weight percent of groups other than methylhydrogensiloxane units can be used in this invention.

The polymethylhydrogen organopolysiloxanes of this invention are preferred to have all of the units be methylhydrogensiloxane units, with the end groups preferably being trimethylsiloxy units. Such materials can be for example, Dow Corning® 1107 fluid, available from the Dow Corning Corporation, Midland, Mich. Also found useful in this invention is Rhodorsil Hydrofugent 68, available from Rhodia Corporation, Rock Hill, S.C.

The amount of the polymethylhydrogen organopolysiloxane useful in this invention is in the range of 0.1 to 15 parts based on 100 parts of rubber. Preferred is a use of the material in the range of 0.1 to 7.0 parts, and most preferred is a use in the range of 0.4 to 3.0 parts.

Other materials useful in this invention are cyclic siloxanes that contain silicon hydride, for example, cyclic siloxanes such as 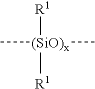
wherein each R¹ is selected from an alkyl of from 1 to 3 carbon atoms, the phenyl group, and the vinyl group, and wherein at least two R¹s in the siloxane chain are hydrogens. The cyclic siloxanes can be cyclic trimer, tetramer, pentamer and hexamer cyclic siloxanes or combinations of the cyclic siloxanes with the linear silicon hydride containing linear siloxanes.

The peroxides useful in this invention are those normally used to cure peroxide cured silicone systems. Thus, contemplated within the scope of this invention, but this invention is not so limited, are such peroxides as dialkyl peroxides, for example, 2,5-dimethyl-2,5-di-(tert-butylperoxy)hexane and Dicumyl peroxide. Further useful peroxides in this invention are the diketal peroxides such as for example, n-butyl 4,4-di(tertbutylperoxy)valerate and 1,1bis-(tertbutylperoxy)-3,3,5-trimethyl-cyclohexane.

Included in the group of peroxides useful in this invention are the diacyl peroxides, for example, dibenzoyl peroxide and dichlorobenzoyl peroxide, and the peroxyester peroxides such as t-butyl-perbenzoate.

Preferred peroxides used in this invention are dialkyl and diketal peroxides. Most preferred peroxides used in this invention are 2,5-dimethyl-2,5-di(tert-butylperoxy) hexane and 1,1-bis-(tert-butylperoxy)-3,3,5-trimethyl-cyclohexane. Commercially available peroxides are Varox DBPH a dialkyl peroxide, Varox DiCup R, a dialkyl peroxide, Varox 230XL, a peroxyketal, Varox 231, a peroxyketal, all sold by R.T. Vanderbilt Co. East Norwalk Conn.; Perkadox S-50S-PS, a diacyl peroxide, and Perkadox PD-50S-PSA, a diacyl peroxide, both manufactured by Akzo Nobel Chemicals, Chicago, Ill., and Lucidol TBPB, a peroxy ester manufactured by Atofina Chemicals, Philadelphia, Pa.

The amount of peroxide useful in this invention is in the range of 0.1 to 10.0 parts, based on 100 parts of the curable silicone in the system.

Also contemplated within the scope of this invention is the use of methylhydrogen siloxane crosslinking agents that are used in conjunction with the above-mentioned composition.

Any organopolysiloxane that contains at least 3 Si-bonded hydrogen atoms per molecule that is commonly used in the preparation of compositions that are cured to form elastomers and rubbers can be used. Such organopolysiloxanes, in addition to the hydrogen atoms, have such groups as methyl, ethyl, phenyl, or the like substituted on those silicon valencies that do not have hydrogen bound thereto. Methyl is the preferred group for this use.

Particularly preferred organopolysiloxanes containing at least 3 Si-bonded hydrogen atoms per molecule are those having the general formula R²(CH₃)₂SiO(SiR²₂O)ₙSi(CH₃)₂R² wherein R² represents hydrogen or the methyl, ethyl or phenyl radical, and ₙ is an integer having a value such that the viscosity of the organopolysiloxane ranges from 15 to 1,000 pa·s at 25° C., with the proviso that only one hydrogen atom is bonded to any one silicon atom and that the ratio between the number of SiR²₂O units in which both R² radicals are hydrocarbon radicals and the number of units containing Si-bonded hydrogen is 1:1 to 20:1. Preferably, R² is methyl. Such organopolysiloxanes are generally known and are commercially available.

### EXAMPLES

Several liquid silicone rubbers were obtained from various silicone manufacturers as shown on TABLE I below. The A part was not used. Only the B part was used. Part B mainly consists of methylhydrogen organopolysiloxane as a crosslinking agent and a cross linkable methylvinylorganopolysiloxane. The various other ingredients, such as fillers, unreactive diluents, and the like, are not known to the inventors herein and it is believed that they do not play a major role in the invention.

TABLE I

| NUMBER | MANUFACTURER | ADDRESS |
|---|---|---|
| LR3003/50B (50 durometer) | Wacker Silicones | Adrian, Michigan |
| LR3003/70B (70 durometer) | Wacker Silicones | Adrian, Michigan |
| LIM-6050B (50 durometer) | GE Silicones | Waterford, NY |
| KE-1950-50B (50 durometer) | Shin-Etsu Silicone | Akron, Ohio |
| | | (Shin-Cor) |
| 9280-70B (70 durometer) | Dow Corning Corp. | Midland, Michigan |

In addition, two polymethylhydrogensiloxanes were used, one from Dow Corning Corporation known as 1107 Fluid, and Rhodosil H-68 from Rhodia Silicones, New Jersey. Rheometer testing was carried out on each of the samples in the examples using an Alpha Technologies MDR2000 rheometer at 148.9° C. TC90 and TS1 were measured using the method set forth in ASTM D 5289-95 with an arc of 0.5 degrees.

### Example 1 Rheometer Results of Liquid Silicone Rubber with VAROX DBPH and SiH at Various Levels

Using only the B side of the materials set forth above in TABLE I, to each 100 parts of such material, was added 1 part per hundred of Varox DBPH. Each of the samples was divided into 3 parts wherein 0.0, 1.0, and 7.0 parts of polymethylhydrogen siloxane was added. Also tested was a liquid siloxane material that is a curable vinyl containing siloxane without any peroxide or silicon hydride added to it before the test below. The results are shown in TABLE II below.

TABLE II

| | polymethylhydrogen additive | | | | | |
|---|---|---|---|---|---|---|
| CURABLE | 0.0 phr | | 1.0 phr | | 7.0 phr | |
| SILICONE | TC90 | TS1 | TC90 | TS1 | TC90 | TS1 |
| LR3003/70 | 520 | 199 | 366 | 137 | 131 | 66 |
| KE1950-50 | 447 | 260 | 262 | 150 | 134 | 80 |
| LIM6050 | 388 | 186 | 58 | 28 | 34 | 21 |
| XLS60 | 1386 | 499 | 352 | 171 | 143 | 70 |

This data shows that TC90 can be reduced up to 85% with addition of 1.0 phr of SiH. TS1 also has the same level of reduction. Decreases in TC90 and TS1 are observed as the SiH levels increase.

### Example 2 Rheometer Results of Liquid Silicone Rubber with VAROX 231 and SiH at Various Levels

The experiments as set forth in Example 1 were repeated using VAROX 231 in place of the VAROX DBPH. The results are shown in TABLE III below.

TABLE III

| | polymethylhydrogen additive | | | | | |
|---|---|---|---|---|---|---|
| CURABLE | 0.0 phr | | 1.0 phr | | 7.0 phr | |
| SILICONE | TC90 | TS1 | TC90 | TS1 | TC90 | TS1 |
| LR3003/70 | 170 | 43 | 130 | 76 | 44 | 22 |
| KE1950-50 | 103 | 48 | 76 | 37 | 38 | 25 |
| LIM6050 | 86 | 35 | 70 | 30 | 36 | 22 |
| XLS60 | 366 | 92 | 109 | 44 | 42 | 23 |

This data shows that TC90 can be reduced by up to 70% with the addition of 1.0 phr of SiH using VAROX 231 as the peroxide. TS1 also reaches significant reduction. Additional decreases in TC90 and TS1 are observed as the SiH levels increase.

### Example 3 Rheometer Results of Liquid Silicone Rubber with PERKADOX S-50S-PS and SiH at Various Levels

The experiments as set forth in EXAMPLE 1 were repeated using Perkadox S-50S-ps in place of the VAROX DBPH. The results are shown in TABLE IV below.

TABLE IV

| | amount of polymethylhydrogen additive | | | | | |
|---|---|---|---|---|---|---|
| CURABLE SILICONE/ | 0.0 phr | | 0.5 phr | | 1.0 phr | |
| With Perkadox S-50S-ps* | TC90 | TS1 | TC90 | TS1 | TC90 | TS1 |
| XLS60 with 1 phr | 382 | 294 | 347 | 235 | 329 | 180 |
| XLS60 with 2 phr | 298 | 86 | 290 | 86 | 281 | 81 |

*this peroxide is not a vinyl specific peroxide

### Example 4 Rheometer Results of Liquid Silicone Rubber with SiH and VAROX DBPH at Various Levels

In this Example, the level of SiH was maintained at 1.0 phr and the level of VAROX DBPH was changed. The results are shown in TABLE V below.

TABLE V

| | Varox DBPH addition | | | | | |
|---|---|---|---|---|---|---|
| CURABLE | 1.0 phr | | 3.0 phr | | 7.0 phr | |
| SILICONE | TC90 | TS1 | TC90 | TS1 | TC90 | TS1 |
| LR3003/30 | 303 | 151 | 220 | 81 | | |
| KE1950-50 | 262 | 150 | 180 | 85 | 130 | 79 |
| LIM6050 | 58 | 28 | 155 | 73 | 73 | 17 |
| XLS60 | 352 | 172 | 243 | 93 | 163 | 72 |

### Example 5 Rheometer Results of Liquid Silicone Rubber with SiH and VAROX 231 at Various Levels

This Example was the same as in Example 4 except that VAROX 231 was used as the peroxide. The results are shown in TABLE VI below.

TABLE VI

| | Varox 231 addition | | | | | |
|---|---|---|---|---|---|---|
| CURABLE | 1.0 phr | | 3.0 phr | | 7.0 phr | |
| SILICONE | TC90 | TS1 | TC90 | TS1 | TC90 | TS1 |
| LR3003/30 | 69 | 35 | 66 | 25 | | |
| KE1950-50 | 76 | 37 | 85 | 25 | 99 | 21 |
| LIM6050 | 70 | 30 | 55 | 22 | 82 | 18 |
| XLS60 | 109 | 44 | 59 | 28 | 52 | 25 |

As shown, the cure rate increases with both the addition of peroxide and with the addition of SiH. The rate of cure is temperature dependent with each of the peroxide classes discussed herein. Smaller rate increases are observed with the diacyl peroxide classes than are observed with any of the other classes.

### Example 6 Temperature Dependence of Rate on Various Catalysts or Peroxides

| | LR3003/30B with Catalyst or peroxide and Si—H | | | | | | | |
|---|---|---|---|---|---|---|---|---|
| Tem- | LR3003/ | | Varox | | Varox | | Cadox | |
| pera- | 30A | | DBPH | | 231 | | BS | |
| ture (° C.) | TC90 | TS1 | TC90 | TS1 | TC90 | TS1 | TC90 | TS1 |
| 121 | 69 | 45 | — | — | 525 | 356 | 287 | 115 |
| 148 | 21 | 13 | 317 | 161 | 76 | 38 | 42 | 22 |
| 177 | 12 | 9 | 65 | 26 | 22 | 15 | 16 | 12 |
| 204 | 10 | 8 | 24 | 13 | 14 | 10 | 10 | 9 |

The addition of peroxide can be used to cure liquid silicone rubber that contains vinyl groups and the rate can be enhanced with the use of silicon hydride containing siloxanes. The enhanced cure can be used to either reduce the time required to cure a material at the same temperature, or to reduce the temperature required for a given time.

What is claimed is:

1. A curable liquid silicone rubber consisting essentially of:
a. a cross linkable vinyl containing organopolysiloxane wherein each vinyl is bonded to a silicon atom, wherein the average degree of polymerization of the organopolysiloxane is less that 1000;
b. an organic peroxide, and,
c. a material containing silicon hydride selected from the group consisting of
(i) silicon hydride containing linear siloxanes,
(ii) silicon hydride containing cyclic siloxanes,
(iii) copolymers of linear silicon hydride containing siloxanes and other linear siloxane polymers,
(iv) combinations of any of (i) to (iii),
wherein all of the silicon hydride units in the linear siloxanes are non-terminal units and wherein there are at least 20 silicon hydride units in the linear silicon hydride siloxanes.

2. The curable liquid silicone rubber as claimed in claim 1 wherein there is also present a hydrogen-containing organopolysiloxane crosslinker.

3. The liquid silicone rubber as claimed in claim 1 wherein the components a. to c. are formed into one part.

4. The liquid silicone rubber as claimed in claim 1 wherein there is also present a filler that is thermally non-conductive.

5. The liquid silicone rubber as claimed in claim 4 wherein the filler is a silica filler.

6. The liquid silicone rubber as claimed in claim 1 wherein component b. is selected from the group consisting of:
i. dialkyl peroxides;
ii peroxyketals,
iii peroxyester peroxides,
iv diacyl peroxides, and
v mixtures of i to iv.

7. The liquid silicone rubber as claimed in claim 6 wherein component b. is 2,5-dimethyl-2,5-di-(tert-butylperoxy)hexane.

8. The liquid silicone rubber as claimed in claim 6 wherein component b is dicumyl peroxide.

9. The liquid silicone rubber as claimed in claim 6 wherein component b is n-butyl 4,4-di(tert-butylperoxy)valerate.

10. The liquid silicone rubber as claimed in claim 6 wherein component b is 1,1bis-(tertbutylperoxy)-3,3,5-trimethyl-cyclohexane.

11. The liquid silicone rubber as claimed in claim 6 wherein component b is dibenzoyl peroxide.

12. The liquid silicone rubber as claimed in claim 6 wherein component b is dichlorobenzoyl peroxide.

13. The liquid silicone rubber as claimed in claim 6 wherein component b is t-butyl-perbenzoate.
